(19) United States
(12) Patent Application Publication
(10) Pub. No.: US 2008/0139978 A1
(43) Pub. Date: Jun. 12, 2008

(54) APPARATUSES AND METHODS FOR COMBINING LIMB SHAPING WITH VIBRATIONAL TREATMENT OF BONES

(76) Inventors: Roger J. Talish, Hillsborough, NJ (US); Arthu Lifshey, East Brunswick, NJ (US); William Walsh, Maroubra (AU)

Correspondence Address: CARTER, DELUCA, FARRELL & SCHMIDT, LLP, 445 BROAD HOLLOW ROAD, SUITE 225, MELVILLE, NY, 11747, US

(21) Appl. No.: 11/951,876

(22) Filed: Dec. 6, 2007

Related U.S. Application Data
(63) Continuation-in-part of application No. 11/950,368, filed on Dec. 4, 2007.
(60) Provisional application No. 60/873,327, filed on Dec. 7, 2006.

(51) Int. Cl. A61H 1/00

(52) U.S. Cl. 601/46; 601/67

(57) ABSTRACT

A method and system for limb shaping and treating bone tissue, including: (a) subjecting a patient, including the bone tissue, to a vibrational stimulus that generates resonant vibrations; and (b) repeating step (a) to treat the bone tissue; wherein a vibrational treatment apparatus capable of generating the resonant vibrations is at least one of directly attached and incorporated to a limb shaping system. The limb shaping system can be an Ilizarov system.

### PRIORITY

This application is a continuation-in-part application from an application filed on Dec. 4, 2007 and assigned U.S. patent application Ser. No. 11/950,368 which claims priority to a U.S. provisional application filed on Dec. 7, 2006 and assigned U.S. Provisional Application Ser. No. 60/873,327; the contents of both applications are incorporated herein by reference.

### BACKGROUND

1. Technical Field

The present disclosure relates to apparatuses and methods for combining limb shaping with vibrational treatment of bones. More particularly, the present disclosure relates to apparatuses and methods for combining limb shaping with vibrational treatment of bone tissue following a bone-related medical procedure.

The bone-related medical procedure can be performed due to a musculoskeletal-related injury, bone-related condition, such as osteoporosis, bone deformities, or other musculoskeletal related conditions. Some types of bone-related medical procedures include a procedure which entails providing a synthetic bone graft material or bone void filler to influence or facilitate bone ingrowth; a procedure which entails stabilizing a bone fracture by inserting pins through the skin and the bone; limb shaping procedures which entails using external fixators for limb lengthening (distraction osteogenesis) and/or limb straightening; a procedure which entails attaching a limb; a procedure which entails providing the patient with a cast, such as providing the patient with a cast surrounding a portion of a limb or an entire body cast; and joint fusion, a procedure which entails permanently fusing bones, such as in the case of an unnatural fracture of the ankle and spinal fusion procedures using spinal cages.

One type of bone-related medical procedure utilized during bone shaping treatments of particular interest in the present disclosure is the Ilizarov method, which permits bone lengthening at a rate of 1.0 to 1.5 mm per day.

2. Description of the Related Art

A method of using resonant vibrations for treating postural instability (thus affecting the musculoskeletal system of a patient) is described in U.S. Pat. No. 6,607,497. The method includes the steps of (a) providing a vibration table having a non-rigidly supported platform; (b) permitting the patient to rest on the non-rigidly supported platform for a predetermined period of time; and (c) repeating the steps (a) and (b) over a predetermined treatment duration. Step (b) includes the steps of (b1) measuring a vibrational response of the patient's musculoskeletal system using a vibration measurement device; (b2) performing a frequency decomposition of the vibrational response to quantify the vibrational response into specific vibrational spectra; and (b3) analyzing the vibrational spectra to evaluate at least postural stability.

The method described in U.S. Pat. No. 6,607,497 entails the patient standing on the vibration table or unstable standing platform which includes at least one accelerometer mounted to the outboard side thereof. The patient is then exposed to a vibrational stimulus by the unstable standing platform. The unstable standing platform causes a vibrational perturbation of the patient's neuro-sensory control system. The vibrational perturbation causes signals to be generated within at least one of the patient's muscles to create a measurable response from the musculoskeletal system. These steps are repeated over a predetermined treatment duration for approximately ten minutes a day in an effort to improve the postural stability of the patient.

### SUMMARY

In accordance with the present disclosure, apparatuses and methods are described for combining limb shaping with vibrational treatment of bones.

One technique used during limb shaping is limb-lengthening treatment, which entails using the Ilizarov method. The Ilizarov method is a bone lengthening technique, whereby a bone is lengthened at a rate of 1.0 to 1.5 mm per day. The gradual distraction allows the neurovascular bundle and muscles to lengthen safely. In addition, osteotomy is performed at lower metaphyseal levels for enhanced bone healing. The Ilizarov system is used in a surgical procedure that can be utilized to lengthen and/or shaping limb bones. The procedure is often used to treat complex and/or open bone fractures, where conventional treatment techniques cannot be used. The procedure involves breaking the bone to be adjusted. Metal rings are then attached to the bone sections by rods, wires, and screws. The screws are then periodically adjusted while the bone is healing to get the required shape. Once this has been completed a second operation is performed to remove the apparatus. An advantage of the Ilizarov method (i.e., a limb shaping procedure using the Ilizarov system) is that the Ilizarov system provides support while the bone is recovering thus enabling the patient to remain relatively active during the majority of the treatment.

The vibrational treatment entails using a vibrating inertia device. Other apparatus for creating resonant vibrations for vibrational treatment are described in U.S. patent application filed on Jul. 18, 2006 titled “Vibrational Therapy Assembly for Treating and Preventing the Onset of Deep Venous Thrombosis” and assigned U.S. patent application Ser. No. 11/488,227; U.S. patent application filed on Jul. 17, 2006 titled “Dynamic Motion Therapy Apparatus Having a Treatment Feedback Indicator” and assigned U.S. patent application Ser. No. 11/487,677; U.S. patent application filed on Mar. 24, 2006 titled “Apparatus and Method for Monitoring and Controlling the Transmissibility of Mechanical Vibration Energy During Dynamic Motion Therapy” and assigned U.S. patent application Ser. No. 11/388,286; and U.S. patent application filed on Mar. 6, 2006 titled “Supplemental Support Structures Adapted to Receive a Non-invasive Dynamic Motion Therapy Device” and assigned U.S. patent application Ser. No. 11/369,611; the entire contents of these U.S. patent applications are incorporated herein by reference.

The vibrational treatment is also known as dynamic motion therapy and its effects on the musculoskeletal system are described at www.juvent.com.

### BRIEF DESCRIPTION OF THE DRAWINGS

FIG. 1 is a perspective view showing a vibrational treatment apparatus in accordance with the present disclosure;

FIG. 2 is a cross-sectional top view showing an Ilizarov apparatus in accordance with the present disclosure;

FIG. 3 is a perspective view showing a vibrational treatment apparatus directly attached to an Ilizarov apparatus in accordance with the present disclosure;

FIG. 4 is a perspective view showing a first and second vibrational treatment apparatus incorporated into an Ilizarov apparatus in accordance with the present disclosure;

FIG. 5 is a perspective view showing an energy moving device in accordance with the present disclosure;

FIG. 6 is a perspective view showing a bone treatment system including a vibrational treatment apparatus directly attached to an Ilizarov apparatus in accordance with the present disclosure;

FIG. 7 is a perspective view showing a bone treatment system including a vibrational treatment apparatus attached to an arm of a patient, in accordance with the present disclosure;

FIG. 8 is a perspective view showing a bone treatment apparatus including a vibrational treatment apparatus attached to the back of a patient in accordance with the present disclosure; and

FIG. 9 is a perspective view showing a bone treatment apparatus, similar to the one shown by FIG. 8 capable of being rotated in accordance with the present disclosure.

### DETAILED DESCRIPTION OF PREFERRED EMBODIMENTS

The present disclosure describes apparatuses and methods for combining limb shaping with vibrational treatment of bones. The apparatuses and methods according to the present disclosure are typically employed following a determination that vibrational treatment of a patient's bone following a limb shaping medical procedure would produce a beneficial result.

Several bone-related medical procedures which the apparatus and methods described herein can be used following the performance thereof include a procedure which entails providing a synthetic bone graft material or bone void filler to influence or facilitate bone ingrowth (see Walsh, W. R., et al., “Influence of Dynamic Motion Therapy on bone ingrowth into a bone graft substitute” which is submitted herewith and whose entire disclosure, including photographs, is a part of this provisional application); a procedure which entails stabilizing a bone fracture by inserting pins through the skin and the bone; a procedure which entails using external fixators for limb lengthening (distraction osteogenesis), limb straightening and/or limb shaping; a procedure which entails attaching a limb; a procedure which entails providing the patient with a cast, such as providing the patient with a cast surrounding a portion of a limb or an entire body cast; and joint fusion, a procedure which entails permanently fusing bones, such as in the case of an unnatural fracture of the ankle and spinal fusion procedures using spinal cages. The vibrational treatment apparatus and method can also be used following other bone-related medical procedures which are not listed above. Preferably, the bone-related medical procedure that the present disclosure relates to is a limb shaping procedure, such as may be performed using the Ilizarov method.

The Ilizarov method is a limb correction process for reshaping injured or deformed limbs, involving little invasive treatment. This method introduced the concept of law of tension-stress, which describes the process of new bone and soft tissue regeneration under the effect of slow and gradual distraction. It relies on the body's ability to heal itself through distraction osteogenesis.

In the first phase of the Ilizarov method, the surgeon performs a minimally invasive procedure, an osteotomy, in which the bone that is to be lengthened is cut.

In the second phase, distraction osteogenesis is achieved by surgically applying an external fixator and then creating a special fracture of the affected bone called a corticotomy. This bone cut is performed through a very small incision, leaving the surrounding muscle and periosteum, with its healing blood supply, attached to the bone. The external fixator is designed and built before surgery to match the existing deformity. It is attached to the limb through bone by thin steel wires and thick pins. The thin steel wires, preferably of 1.5 mm diameter, are passed percutaneously (through the skin) through bones by means of a drill. The protruding ends of these wires are then preferably fixed to rings with special wire-fixation bolts. These rings in turn are connected and fixed to one another by threaded rods. Once it is fixed, the Ilizarov frame affords a stable support to the affected limb.

In the third phase, postoperatively, under the direction of the surgeon, the patient gradually adjusts the fixator, slowly reshaping the bone to correct the length or deformity. As the bone segments separate, new bone tissue forms in the gap, ultimately assuming the strength of the original bone. It takes between 5 and 10 days for the body's natural inflammatory response to occur. As a result, the actual lengthening or straightening of the bone begins. During this time period, the patient or a family member adjusts the small wheel on the fixator at designated times during the day. Typically, the bone is pulled apart at a rate of 1 millimeter a day (about 1/25 of an inch) and the body's response is to grow new bone to fill the gap.

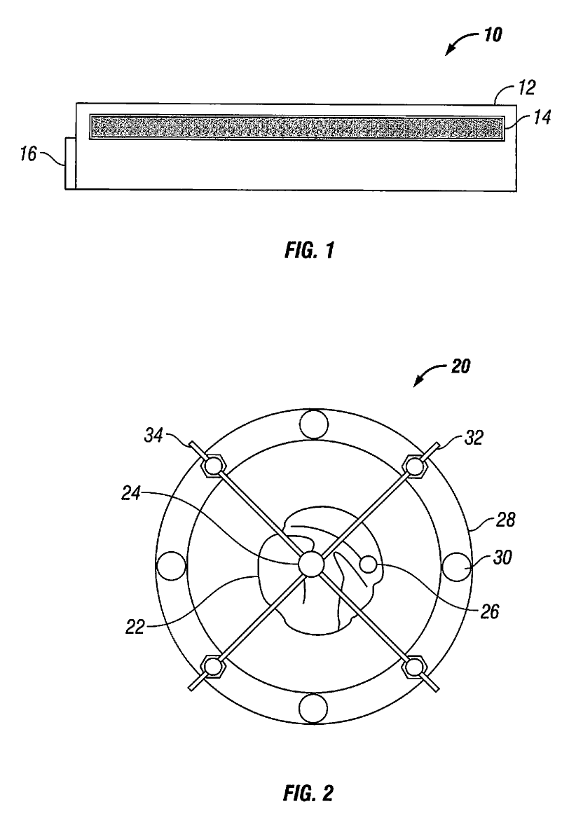

Referring to FIG. 1, an exemplary vibrational treatment apparatus in accordance with an embodiment of the present disclosure is illustrated and designated generally by reference numeral 10. The vibrational treatment apparatus 10 includes a vibrational support 12, an energy moving device 14, and an accelerometer 16.

The vibrational support 12 is configured to hold the energy moving device 14. The vibrational support 12 may be constructed by using any of a plurality of materials.

The energy moving device 14 is configured to vibrate for subjecting the musculoskeletal system, including the bone requiring treatment following a bone-related medical procedure, e.g., the Ilizarov method, to a vibrational stimulus while the patient is using the vibrational treatment apparatus 10. The energy moving device 14 preferably vibrates to produce resonant vibrations having a frequency suitable for treating bone, and is discussed in more detail infra. The resonant vibrations provide the vibrational stimulus at substantially the same frequency to the bone tissue. Vibrational treatment is preferably performed at a predetermined frequency for a predetermined period of time and for a predetermined treatment duration depending on one or more parameters. The parameters include the type of bone tissue requiring vibrational treatment, the location of the bone tissue, factors relating to the patient (age, sex, weight, postural stability, etc.), whether the patient has any abnormalities, and/or the condition of the patient and/or bone tissue (stiffness, brittleness, etc.) requiring vibrational treatment. At least one low-mass accelerometer 16 may be mounted to the vibrational treatment apparatus 10 on an outer side of the vibrational treatment apparatus 10 as described in U.S. Pat. No. 6,607,497, the contents of which are incorporated herein by reference. Accelerometer 16 is used to measure the vibrational response of the patient's musculoskeletal system to simultaneously determine postural stability of the patient, if so desired, using the method described in U.S. Pat. No. 6,607,497, while providing vibrational treatment to the bone in accordance with the present disclosure.

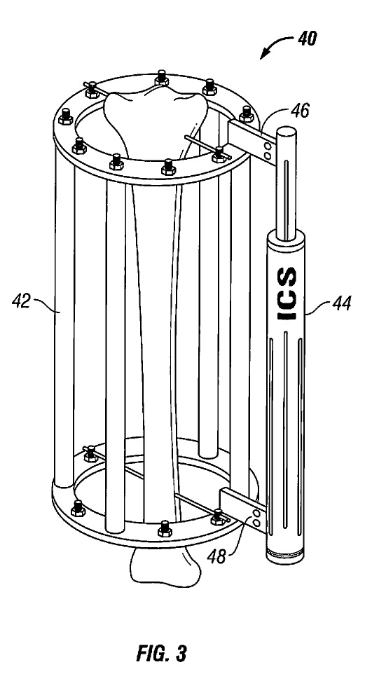

FIG. 2 is a cross-sectional top view showing a conventional Ilizarov system 20 in accordance with the method of the present disclosure. The bone tissue requiring treatment may be located within the patient's leg, i.e., the bone tissue of the tibia or may be located on the patient's spine. The Ilizarov system 20 includes a series of concentric metal rings 28 having a plurality of rods 30, which connect to at least two metal rings 28 in a variety of configurations. The two metal rings 28 are placed, for example, around a patient's leg (see FIG. 3). FIG. 2 also shows a cross-sectional view of a patients' leg. The soft tissue 22 of the leg includes a tibia 24 and a fibula 26. A first wire 32 passes through at least two rods 30, through the soft tissue 22 and the tibia 24 of the patient's leg, thus securing the patient's leg to the Ilizarov system 20. A second wire 34 passes through at least two rods 30, through the soft tissue 22 and the tibia 24 of the patient's leg, thus securing the patient's leg to the Ilizarov system 20.

Therefore, the Ilizarov system 20 is used in surgical procedures to lengthen or reshape limb bones, such as the tibia 24. However, the Ilizarov system can be used on various bones of the human body. The surgical procedure is often used to treat complex and/or open bone fractures, where conventional treatment techniques cannot be used. The surgical procedure involves breaking the bone to be adjusted, for example the tibia 24. The at least two metal rings 28 are then attached to the bone sections by rods 30, wires 32, 34, and/or screws (not shown). The screws are then periodically adjusted while the bone is healing to get the required shape. Once this has been completed the fixator is removed.

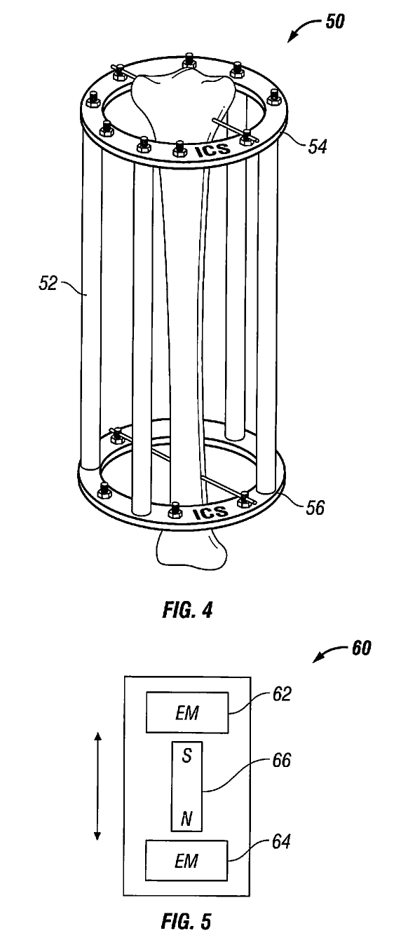

FIG. 3 is a perspective view showing a vibrational treatment apparatus, similar to the vibrational treatment apparatus 10 shown by FIG. 1 and having an energy moving device 14 (this apparatus is also identified as an inertia coupling system or ICS in the figures and can be straight (FIG. 3), circular (FIG. 4), or any other shape), attached to an Ilizarov system in accordance with an embodiment of the present disclosure. The combined system 40 includes an Ilizarov system 42 and a vibrational treatment apparatus 44. The vibrational treatment apparatus 44 is attached to the Ilizarov system 42 via a top attachment mechanism 46 and a bottom attachment mechanism 48. The top and bottom attachment mechanisms 46, 48 can include several different mechanisms, such as pins, screws, fastening assemblies or any other type of reliable attachment mechanism.

Therefore, in the first embodiment of the present disclosure, the vibrational treatment apparatus 44 may be attached to any of the rods 30 that hold together the metal rings 28 (shown in FIG. 2). Preferably, the vibrational treatment apparatus 44 is in the shape of a metal rod approximately equal to the length of the Ilizarov system 42. The vibrational treatment apparatus 44 may be positioned on the inner perimeter or the outer perimeter of the metal rings 28 of the Ilizarov system 42.

During treatment according to the method of the present disclosure, the vibrational treatment apparatus 44 is attached to the Ilizarov system 42. Vibrations generated by the energy moving device 14 (shown in FIG. 1) for a predetermined period of time, for example, ten minutes, are transmitted through the patient's body and to the bone tissue of the tibia 24 of the patient's leg that requires vibrational treatment via the metallic structure of the Ilizarov system 42. However, the predetermined period of time may vary depending on the limb receiving treatment. The vibrations generated by the energy moving device 14 when using the Ilizarov system for bone shaping, bone lengthening, and/or bone repair, can have an amplitude of 0.1 g to 0.5 g, but preferably, from 0.2 g to 0.5 g. The vibrations generated by the energy moving device 14 can be from 1 to 20 minutes per treatment with preference from 10 to 20 minutes per treatment with a frequency in the range of 20 to 120 Hertz with a preference from 30 to 90 Hertz. The energy moving device 14 should create displacements in the vibrational treatment apparatus 44 from 5 to 100 microns with a preference in the 10-50 micron range. The vibrations should cause the gap in the bone to displace about 10 to 50 microns and/or about 10% displacement of the aggregate gap. A surgeon may have the ability to control the displacement occurring between the bones in terms of distance and/or in terms of a fractional relationship of the total bone displacement while keeping frequency and/or treatment time fixed.

For example, for bones located in the leg of a person, the frequencies imparted by the vibration treatment apparatus 10 may be in the range between 30-90 Hz with a peak amplitude between 0.04 and 0.4 g for bones located in a patient's leg. Preferably, the frequency of the vibration treatment apparatus 10 is approximately 30 Hz and the peak amplitude is 0.3 g. However, the preferred frequencies may vary according to the limb or bone desired to be treated.

In addition, the vibration waves are preferably sinusoidal, however other waveforms are contemplated. Typically, the resonant vibrations provide the vibrational stimulus at substantially the same frequency to the bone tissue. The vibrational stimulus causes the bone tissue to shake or vibrate at a vibrational frequency for producing a beneficial healing effect. The method also includes the step of evaluating a healing response of the bone tissue. Preferably, the predetermined period of time is approximately ten minutes and the predetermined treatment duration is at least four weeks.

FIG. 4 is a perspective view showing a first and a second vibrational treatment apparatus incorporated to an Ilizarov system in accordance with a second embodiment of the present disclosure. The combined system 50 includes an Ilizarov system 52 and at least two vibrational treatment apparatuses 54, 56. The first vibrational treatment apparatus 54 replaces a top metal ring of the Ilizarov system 52. The second vibrational treatment apparatus 56 replaces a bottom metal ring of the Ilizarov system 52. The vibrational treatment apparatuses 54, 56 may be incorporated to the Ilizarov system 52 by a variety of attachment mechanisms, such as pins, screws, or any other type of reliable attachment mechanism.

Therefore, in the second embodiment of the present disclosure, the vibrational treatment apparatuses 54, 56 may be attached to the rods in a similar manner as the metal rings 28 are attached to the Ilizarov system 40 show by FIG. 3. In this embodiment, the vibrational treatment apparatuses 54, 56 are of a circular or oval shape almost equal to the circumference of the metal rings 28 of the Ilizarov system 40.

Referring to FIG. 5, a perspective view showing an energy moving device which can be incorporated within the various vibrational treatment apparatuses described herein in accordance with the present disclosure. The at least one energy moving device 60 can be similar in structure to the energy moving device 12 shown by FIG. 1. The energy moving device 60 includes two electromagnets 62, 64 with opposite polarities. An electromagnet is a type of magnet in which the magnetic field is produced by the flow of an electric current. The magnetic field disappears when the current ceases. The main advantage of an electromagnet over a permanent magnet is that the magnetic field can be rapidly manipulated over a wide range by controlling the amount of electric current. Thus, a continuous supply of electrical energy is required to maintain the field. The simplest type of electromagnet is a coiled piece of wire. A coil forming the shape of a straight tube (similar to a corkscrew) is called a solenoid; a solenoid that is bent so that the ends meet is a toroid. Much stronger magnetic fields can be produced if a core of paramagnetic or ferromagnetic material is placed inside the coil. The core concentrates the magnetic field that can then be much stronger than that of the coil itself. Preferably, the electromagnets 62, 64 of the present disclosure are solenoids.

A third magnet 66 is placed in between the two electromagnets 62, 64 in order to obtain linear vibration (or rotational or semi-circular vibration where the vibrational treatment apparatus has a circular configuration as shown in FIG. 3) via reverse polarity. The magnet 66 is a permanent magnet. By placing the magnet 66 in between electromagnets 62, 64, the energy moving device 60 may vibrate at a desired frequency by applying an appropriate current through the electromagnets 62, 64.

In another embodiment, the energy moving device may be selected from the group consisting of speakers, air moving devices (blowers and fans) and sub-woofers, or combinations thereof. Preferably, the energy moving device includes a plurality of speakers positioned near the bone tissue to be treated. The plurality of speakers may generate low frequency waves in a manner described hereinabove. Moreover, each speaker may be configured to generate waves having a frequency different from the frequencies of the waves generated by the other speakers. Accordingly, bone tissue can be subjected to a vibrational stimulus produced by waves having frequencies (delivering broadband of signals).

In another embodiment, the energy moving device may also be a spring loaded solenoid for creating the required vibration. The spring mechanism may be a motorized or a non-motorized spring mechanism, which causes the vibrational support 12 (shown in FIG. 1) to be turned on or vibrate.

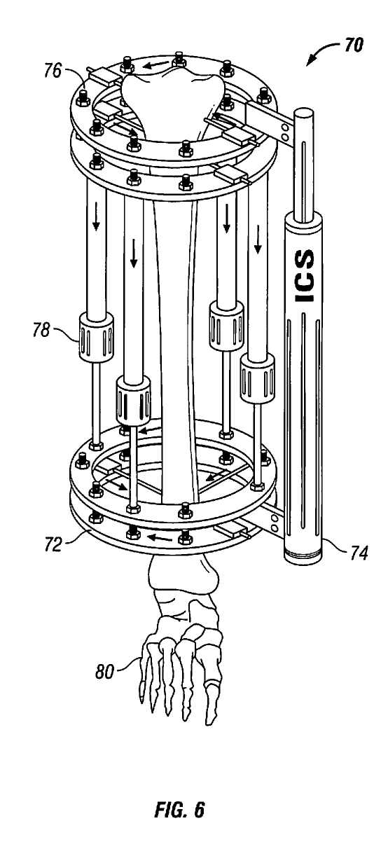

Referring to FIG. 6, a perspective view showing a bone treatment system including a vibrational treatment apparatus directly attached to an Ilizarov system in accordance with a third embodiment of the present disclosure is illustrated. The bone treatment system 70 includes an Ilizarov system 72 and a vibrational treatment apparatus 74. The vibrational treatment apparatus 74 is attached to the Ilizarov system 72. In this exemplary embodiment, the vibrational treatment apparatus 74 is attached to one or more metal rings 76 that are held together by a plurality of rods 78. As illustrated in FIG. 6, a bone 80 is positioned within the Ilizarov system 72. Once vibrational energy is applied to the bone 80 for a predetermined period of time, the patient or physician may adjust the vibrational treatment apparatus 74 in order to perform the limb lengthening procedure.

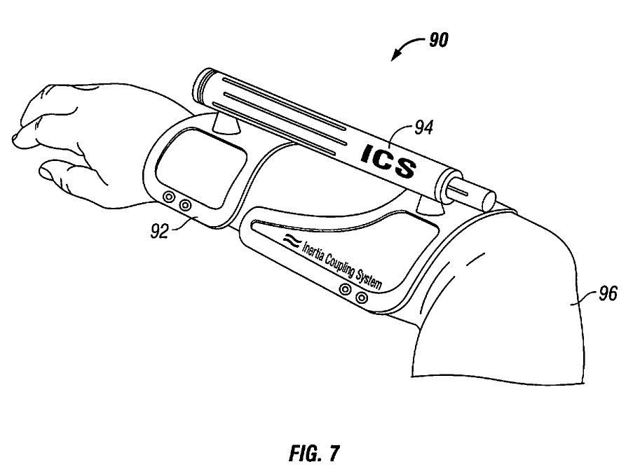

Referring to FIG. 7, a perspective view showing a bone treatment system including a vibrational treatment apparatus attached to an arm of a patient, in accordance with a fourth embodiment of the present disclosure is illustrated. The bone treatment system 90 includes an attachment device 92 and a vibrational treatment apparatus 94. The vibrational treatment apparatus 94 is attached to the attachment device 92, which is in turn positioned on an arm 96 of a patient. In this exemplary embodiment, as vibrational energy is applied to the arm 96 for a predetermined period of time, the patient or physician may adjust the vibrational treatment apparatus 94 in order to provide vibrational treatment to the patient.

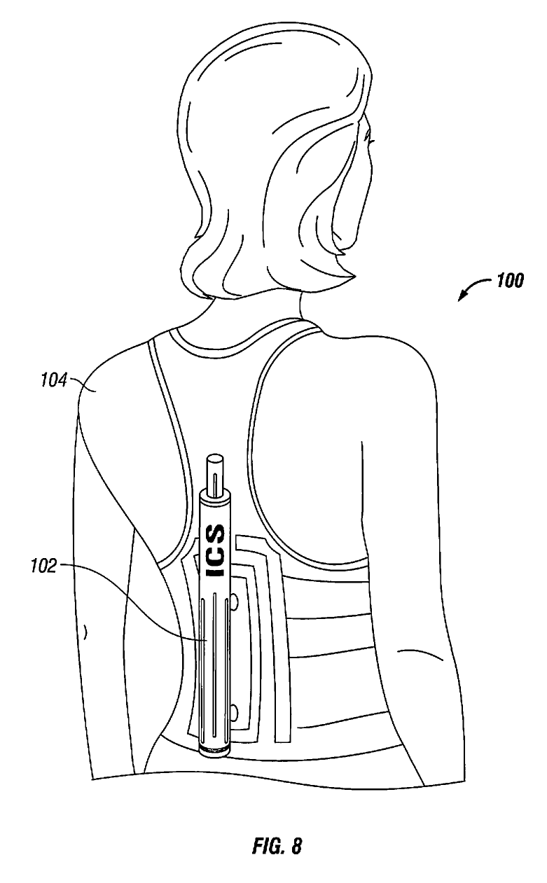

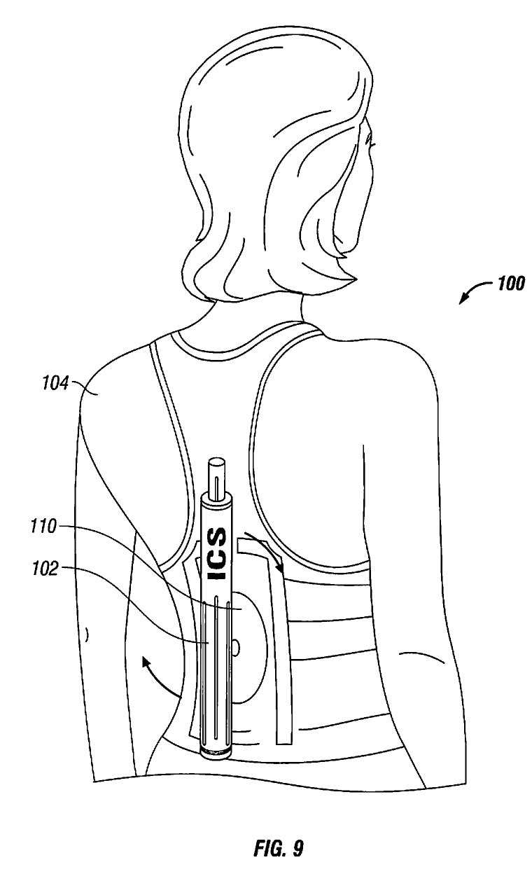

Referring to FIG. 8, a perspective view showing a bone treatment system including a vibrational treatment apparatus attached to the back of a patient, in accordance with a fifth embodiment of the present disclosure is illustrated. The bone treatment system 100 includes a vibrational treatment apparatus 102 that is mounted to a person 104. The vibrational treatment apparatus 102 is attached by a variety of means to the back of the person 104, such as a specially-designed garment as shown by FIG. 8. Preferably, the apparatus 102 is attached to the garment via a metallic interface to enable the resonant vibrations generated by the apparatus 102 to be transmitted to the patient, especially to the bone to be treated, via the metallic interface. The apparatus 102 can also be rotationally mounted to the metallic interface to enable the apparatus 102 to be rotated as shown by FIG. 9. In this exemplary embodiment, as vibrational energy is applied to the back of the person 104 for a predetermined period of time, the patient or physician may adjust the vibrational treatment apparatus 102 in order to provide vibrational treatment to the patient.

During vibrational treatment, the energy moving device 60 generates vibratory energy which is focused to the bone requiring vibrational treatment in accordance with the method of the present disclosure. The at least one energy moving device 60 may generate waves having a frequency in the range of 1 Hz to 100 KHz. The waves, as the resonant vibrations described above, provide a vibrational stimulus at substantially the same frequency to the bone tissue being treated. Vibrational treatment using the at least one energy moving device 60 is preferably performed at a predetermined frequency for a predetermined period of time and for a predetermined treatment duration depending on one or more parameters. The parameters include the type of bone tissue requiring vibrational treatment, the location of the bone tissue, factors relating to the patient (age, sex, weight, postural stability, etc.), whether the patient has any abnormalities, and/or the condition of the patient and/or bone tissue (stiffness, brittleness, etc.) requiring vibrational treatment. For example, the predetermined frequency is 30 Hz, the predetermined period of time is ten minutes and the predetermined treatment duration is approximately four weeks for bones located in a patient's leg. However, the predetermined period of time may vary depending on the limb receiving treatment.

Furthermore, the method may also include the step of evaluating a healing response of the bone tissue and adjusting at least one of the predetermined period of time and the predetermined treatment duration accordingly. In the apparatus and method in accordance with the present disclosure, the vibrational stimulus provided by the vibratory energy causes the patient and the bone tissue to shake or vibrate for producing a beneficial healing effect for the bone tissue. In addition, the vibrational response is measured and recorded by a spectrum analyzer/computer (not shown) which is electrically connected to the accelerometer 16.

While the methods of the present disclosure utilize a vibrational treatment apparatus as described and shown by the various figures as the fundamental perturbing agent for vibrating the musculoskeletal system, including the bone tissue which has undergone a bone-related medical procedure, it is contemplated that any other apparatus or method can be employed for providing the vibrational stimulus required for vibrationally treating the bone tissue in accordance with the methodology of the present disclosure.

1. A method for limb shaping and treating bone tissue, the method comprising:
(a) subjecting a patient, including the bone tissue, to a vibrational stimulus that produces resonant vibrations; and
(b) repeating step (a) to treat the bone tissue;
wherein a vibrational treatment apparatus capable of generating the resonant vibrations is at least one of directly attached and incorporated to a limb shaping system.

2. The method according to claim 1, further comprising evaluating a healing response of the bone tissue and adjusting at least one of a predetermined period of treatment time and the predetermined treatment duration accordingly.

3. The method according to claim 2, wherein the predetermined period of treatment time is about 10 minutes to about 20 minutes.

4. The method according to claim 1, wherein the frequency of the resonant vibrations is about 30 Hertz to about 90 Hertz.

5. The method according to claim 1, wherein the resonant vibrations have an amplitude of about 0.2 g to about 0.4 g.

6. The method according to claim 1, wherein the vibrational stimulus produces a displacement of about 5 microns to about 100 microns.

7. The method according to claim 1, wherein the vibration stimulus produces a displacement in a gap of the bone tissue of the patient of about 10 microns to about 50 microns.

8. The method according to claim 1, further comprising the step of:
adjusting a displacement of a gap of the bone tissue of a patient, wherein the adjustment is one of a fraction of the gap of the bone tissue and a distance of the displacement of the gap of the bone tissue.

9. The method according to claim 1, wherein the limb shaping system is an Ilizarov system.

10. The method according to claim 1, wherein the vibrational treatment apparatus is attached to at least one of an outer portion of the limb shaping system via a securing mechanism, a top portion of the limb shaping system via the securing mechanism, a bottom portion of the limb shaping system via the securing mechanism.

11. The method according to claim 1, wherein the subjecting step comprises:
providing at least one energy moving device within the vibrational treatment apparatus for generating the resonant vibrations; and
focusing the generated resonant vibrations towards the bone tissue.

12. A system for limb shaping and treating bone tissue, the system comprising:
a vibrational treatment apparatus capable of generating resonant vibrations for subjecting bone tissue to a vibrational stimulus; and
a limb shaping system;
wherein the vibrational treatment apparatus is at least one of directly attached and incorporated to the limb shaping system.

13. The system according to claim 12, further comprising means for evaluating a healing response of the bone tissue.

14. The system according to claim 12, wherein the limb shaping system is an Ilizarov system.

15. The system according to claim 12, wherein the vibrational treatment apparatus is attached to at least one of an outer portion of the limb shaping system via a securing mechanism, a top portion of the limb shaping system via the securing mechanism, a bottom portion of the limb shaping system via the securing mechanism.

16. A method for limb shaping and treating bone tissue, the method comprising:
(a) subjecting a patient, including the bone tissue, to vibratory energy generated by at least one energy moving device for a predetermined period of time; and
(b) repeating step (a) over a predetermined treatment duration to treat the bone tissue;
wherein a vibrational treatment apparatus capable of generating resonant vibrations, and housing the at least one energy moving device, is at least one of directly attached and incorporated to a limb shaping system.

17. The method according to claim 16, wherein the at least one energy moving device is a magnetic configuration for producing linear vibration via reverse polarity.

18. The method according to claim 16, wherein the at least one energy moving device is a spring loaded solenoid configuration for producing linear vibration.

19. The method according to claim 16, further comprising evaluating a healing response of the bone tissue and adjusting at least one of the predetermined period of time and the predetermined treatment duration accordingly.

20. A bone treatment system comprising:
a vibrational support;
at least one energy moving device located within the vibrational support for producing resonant vibrations and for subjecting a patient, including bone tissue, to a vibrational stimulus; and
means for wearing the vibrational support by the patient.

21. The apparatus according to claim 20, further comprising an accelerometer located on an outer surface of the vibrational support for measuring a vibrational response of the patient's musculoskeletal system.
